(19) United States
(12) Patent Application Publication
(10) Pub. No.: US 2017/0248559 A1
(43) Pub. Date: Aug. 31, 2017

(54) COLUMN PACKING APPARATUS AND PACKING METHOD

(71) Applicant: FLOM CORPORATION, Ome City, Tokyo (JP)

(72) Inventors: Satoshi MOTOMIYA, Ome City, Tokyo (JP); Shoji FUNAKOSHI, Ome City, Tokyo (JP)

(21) Appl. No.: 14/417,580

(22) PCT Filed: Jun. 2, 2014
(86) PCT No.: PCT/JP2014/064658

§ 371 Date: Dec. 28, 2016

(51) Int. Cl. G01N 30/56; G05D 7/06; G05D 16/20; B01D 15/20

(52) U.S. Cl. CPC G01N 30/56; B01D 15/206; G05D 7/0635; G05D 16/2013

(57) ABSTRACT

A column packing apparatus includes a tubular structure, a packing material supplier disposed on one end of the tubular structure for permitting a packing material slurry formed by a packing material dispersed in a solvent to be packed into the tubular structure, and a packing controller disposed on the other end of the tubular structure for determining the flow rate and pressure of the packing material slurry formed by the packing material being packed so that they can be maintained at predetermined flow rate and pressure level. A column packing method includes the steps of providing a packing controller disposed on the other end of the tubular structure, and permitting the packing controller to variably adjust the flow rate and pressure of the packing material slurry so that they can be maintained at the predetermined flow rate and pressure level.

### BACKGROUND

Field of the Invention

The presents invention relates to column packing apparatus and method wherein the column structure is designed for use in the chromatographic separation.

Description of the Relevant Art

The liquid chromatography is the technology designed to separate mixture samples as it is known in the conventional prior art fields, in which a mobile phase (such as an eluate) is flowed into a stationary phase (such as a column structure) together with a sample and the resultant mixture sample is separated by utilizing the differences in the rate or speed of movement caused by the differences in the affinity of each individual component contained in the mixture sample. The column structures that have been used for the liquid chromatographic separation are of various types, some of which are known to the prior art in addition to the column structures that have been proposed in the patent documents cited below, for example.

### RELEVANT TECHNICAL DOCUMENTS

### Patent Documents

Patent Document 1: Japanese patent application No. S63 (1988)-134952 (unexamined)

Patent Document 2: Japanese patent application No. S63 (1988)-282650 (unexamined)

Patent Document 3: Japanese patent application No. 2007-139651 (unexamined)

### SUMMARY

FIG. 3 is a concept diagram that represents the principle of operation for the prior art packing process during which a packing material may be packed into the column structure.

In the initial stage of the packing process during which a packing material slurry 12 formed by the packing material dispersed in a solvent 10a is packed into the column structure 2 from a packing material packer 4, the pressure in the column structure 2 is low (FIG. 4) and the packing material slurry 12 is deposited on the bottom of the column structure 2, causing the pressure in the column structure 2 to be rising as the layer of the packing material slurry 12 being deposited on the bottom of the column structure 2 is becoming thicker (FIG. 4).

As the packing for the packing material slurry 12 is going on, the pressure in the column structure 2 will be prevented from rising. When the pressure reaches a predetermined pressure level, the packing process will be stopped. In the reference numerals, 9 denotes a liquid delivery pump, 10 denotes a solvent supply portion, 11 denotes a solvent discharge portion, 13 denotes a pressure sensor, 14a denotes a solvent 10a supply flow path and 14b denotes a solvent discharge flow path.

In the conventional packing process during which the filler packing material is packed into the prior art column structure as described above, the pressure in the column structure is always changing, and it is therefore impossible to form the uniform layer of the filler material slurry within the column structure.

In the initial stage of the filling process during which the packing material slurry is packed into the column structure, it is recognized that the layer of the packing material slurry has a coarse density, which may cause the packing material to be settled down on the bottom of the column structure when the sample is analyzed by the chromatographic separation using the conventional column structure. This may also produce cavities in the entry portion of the column structure (in the upper end 2a of the column structure 2 in FIG. 3), causing the ability or power of the column structure to resolve the mixture sample in the column structure to be reduced remarkably.

In addition, it is recognized that even for the column structure so manufactured as to permit an identical filler material to be filled during the filling process, the pressure in the column structure may be different for each individual column structure.

It is therefore one object of the present invention to provide column packing apparatus and method wherein the column structure provides a uniform pressure under which the layer of the filler material slurry can be deposited therein.

It is another object of the present invention to provide column packing and method wherein the differences in the pressure for each individual column structure can be minimized and the ability or power of the column structure to resolve a sample can be stabilized.

The above objects can be accomplished as follows.

The invention according to Claim 1 provides a column packing apparatus wherein the column structure is designed for use in the chromatographic separation, the apparatus being characterized by the fact that it comprises:

a tubular structure;

a packing material supplier disposed on one end of said tubular structure for permitting packing material slurry formed by a packing material dispersed in a solvent to be packed into said tubular structure; and

a filling controller disposed on the other end of said tubular structure for maintaining the flow rate and pressure of said packing material slurry formed by said packing material being packed at predetermined flow rate and pressure level.

The invention according to Claim 2 provides a column packing apparatus as defined in Claim 1, the apparatus being characterized by the fact that said packing controller includes:

a resistive element for variably adjusting the discharging rate of said solvent being discharged from said other end of said tubular structure, wherein said resistive element is a resistor capable of variably adjusting the discharging rate of said solvent and maintaining the flow rate and pressure of said packing material slurry at said predetermined flow rate and pressure level.

The invention according to Claim 4 according to Claim 3 provides a column packing method wherein the column structure is designed for use in the chromatographic separation, the method being characterized by the fact it comprises the steps of:

providing a tubular structure;

providing a packing material supplier disposed on one end of said tubular structure;

packing a packing material slurry formed by a packing material dispersed in a solvent into said tubular structure from said packing material supplier;

providing a packing controller disposed on the other end of said tubular structure; and

permitting said filling controller to variably adjusting the flow rate and pressure of said packing material slurry so that they can be maintained at predetermined flow rate and pressure level.

The invention according to Claim 4 provides a column packing method as defined in Claim 3, the method being characterized by the fact that said packing controller includes a resistive element for variably adjusting the discharging rate of said solvent being discharged from said other end of said tubular structure, wherein said resistive element is a resistor capable of variably adjusting the discharging rate of said solvent so that the flow rate and pressure of said packing material slurry can be maintained at said predetermined flow rate and pressure level.

One advantage of the present invention lies in providing column packing apparatus and method wherein the column structure provides a uniform pressure under which the layer of the packing material slurry can be deposited therein.

Another advantage of the present invention lies in providing column packing apparatus and method wherein the differences in the pressure for each individual column structure can be minimized and the ability or power of the column structure to resolve the sample can be stabilized.

### BRIEF DESCRIPTION OF DRAWINGS

FIG. 1 is a concept diagram that represents one example of the column packing apparatus in accordance with one embodiment of the present invention;

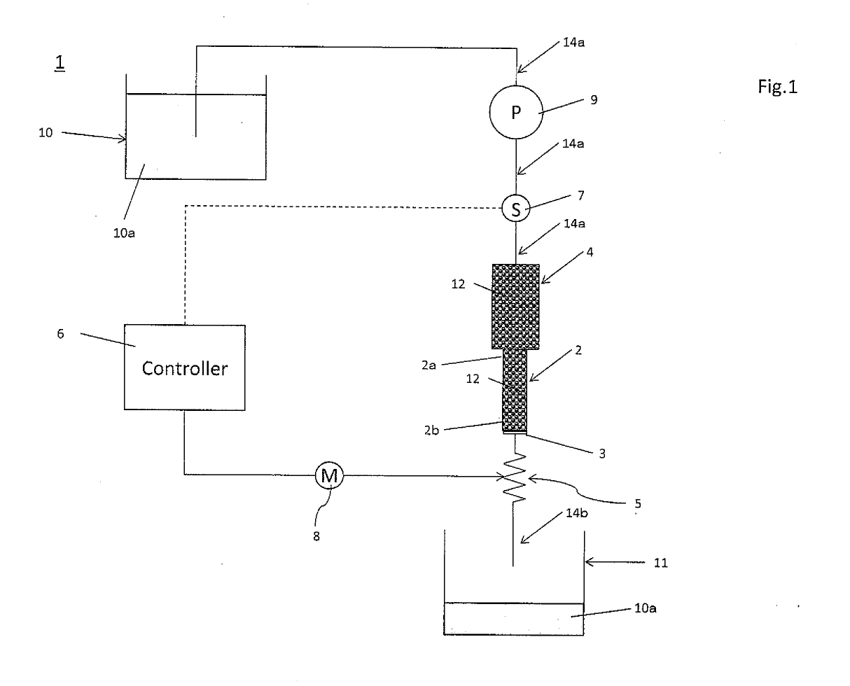

FIG. 2 illustrates one example of the arrangement including the variable resistor and motor arrangement as shown in FIG. 1;

FIG. 3 is a concept diagram that represents the prior art principle of operation for the packing process during which the packing material is packed into the column structure; and

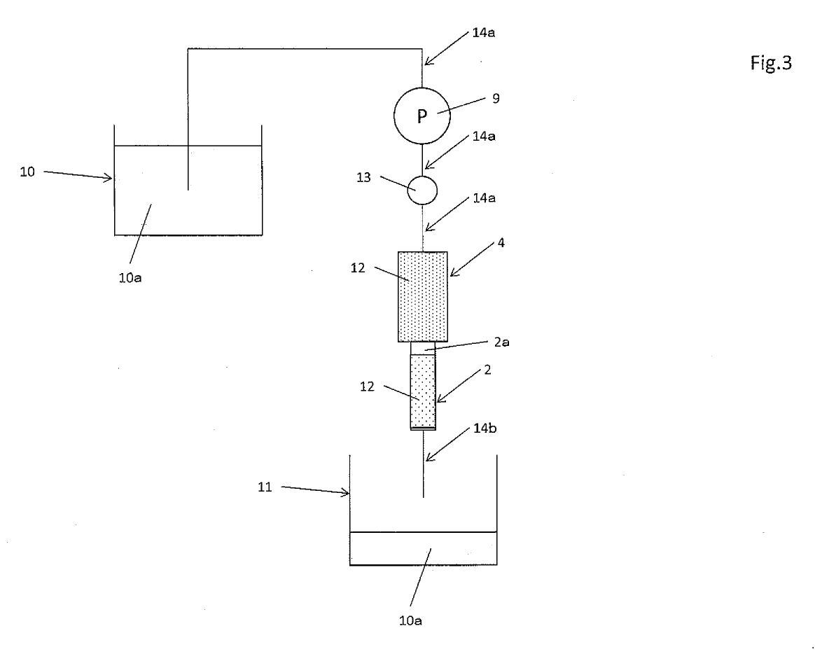

FIG. 4 is a graph diagram that illustrates the relationship between the pressure and the time in the packing process during which the packing material is packed into the column structure shown in FIG. 3.

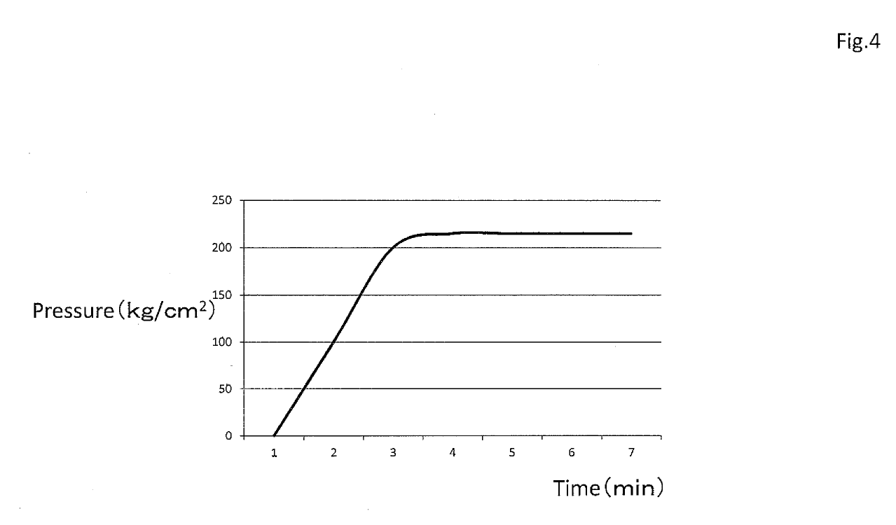

### BEST MODE OF EMBODYING THE INVENTION

One example of the column packing apparatus in accordance with one embodiment of the present invention is now described by referring to the accompanying drawings. In the form shown, the column packing apparatus 1 is provided which comprises a column structure 2 in the tubular form, a packing material supplier disposed on the upper end 2a of the column structure 2 and a packing material slurry 12 formed by a packing material dispersed in a solvent 10a and packed into the column structure 2 from the packing material supplier.

Specifically, the column packing apparatus 1 includes the afore-mentioned packing material supplier, a column structure 2, a discharging container 11 for the solvent 10a and a packing controller for controlling the packing process during which the packing material slurry 12 is packed into the column structure 2.

The afore-mentioned packing material supplier includes a solvent supply container 10, a liquid delivery pump 9, a pressure sensor 7 and a packing material packer 4, all of which are connected by means of a supply flow path for the solvent 10a.

The solvent 10a is supplied from the solvent supply container 10 to the packing material packer 4 at the predetermined pressure level and flow rate by means of the liquid delivery pump 9. An appropriate amount of the packing material is then added to the solvent 10a supplied to the packing material packer 4, and the packing material slurry 12 is formed by the packing material dispersed in the solvent 10a.

The packing material slurry 12 thus formed is packed from the packing material packer 4 into the column structure 2 that is connected to the lower end of the packing material packer 4. The packing material slurry 12 is then deposited within the column structure 2, forming a packing material layer, and the solvent 10a in the packing material slurry 12 passes through a filter 3 fixed to the lower end 2b of the column structure 2, going through the discharge flow path 14b to the discharge container 11 from which the solvent 10a is discharged.

In the form shown, the column packing apparatus 1 includes the packing controller that is provided on the discharge flow path 14b for the solvent 10a located on the discharge container 11 so that it can control the flow rate and pressure level of the packing material slurry 12 for maintaining them at the predetermined flow rate and pressure level. Based on the predetermined flow rate and pressure level thus maintained by the packing controller, the packing material slurry 12 that has been supplied from the afore-mentioned packing material supplier is then packed into the column structure 2.

The afore-mentioned packing controller includes a variable resistor 5 in the form of an adjustable resistance for adjusting the amount of the solvent 10a to be discharged from the column structure 2, a motor 8 that may be driven for moving the variable resistor 5 through the discharge flow path 14b, and a controller 6 for adjustably controlling the flow rate and pressure of the packing material slurry 12 as well as the distance of the variable resistor 5 that may be moved through the discharge flow path 14b.

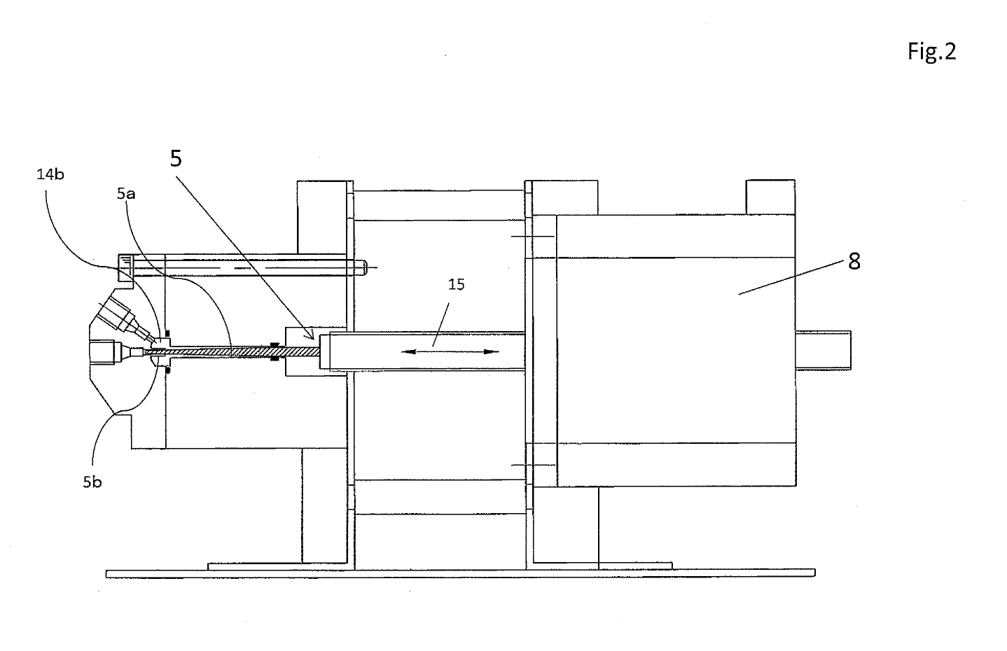

FIG. 2 represents one example of the arrangement including the variable resistor 5 movably disposed through the discharge flow path 14b and the motor 8 drivingly connected to the variable resistor 5.

In the form shown, the variable resistor 5 includes a flow path opening/closing needle 5a that passes through one lateral wall and the other lateral wall of the discharge flow path 14b and a needle receiver 5b disposed on the above-mentioned other lateral wall of the discharge flow path 14b.

The flow path opening/closing needle 5a is driven by the motor 8 so that it can be moved toward the direction indicated by a double arrow 15, and the quantity of the solvent 10a that can be passed through the discharge flow path 14b is adjusted by the distance of the flow path opening/closing needle 5a that may be moved through the discharge flow path 14b.

The controller 6 may be operated so that it can determine the flow rate and pressure level of the packing material slurry 12 through the column structure 2 and it can also determine the distance of the variable resistor 5 that may be moved so that the flow rate and pressure level can be maintained at the appropriate flow rate and pressure level. Based upon the distance of the movement of the variable resistor 5 thus appropriately determined by the controller 6, the corresponding control signals will be transmitted to the motor 8.

Below is described the column packing method that is performed by the column packing apparatus having the constitutional arrangement described above.

The first step is to cause the controller 6 to determine the appropriate flow rate and pressure level of the solvent 10a. The solvent 10a is then supplied by the liquid delivery pump 9 from the solvent supplier 10 to the packing material packer 4 at the appropriate flow rate and pressure level that have been determined by the controller 6.

The second step is to cause the controller 6 to determine the distance of the movement of the variable resistor 5 required for maintaining the flow rate and pressure level at the appropriate flow rate and pressure level as determined by the controller 6. The corresponding control signals based on the appropriately determined distance of the movement will then be transmitted to the motor 8.

The third step is to cause the motor 8 to move the variable resistor 5 through the flow path 14b in one or other direction of the double arrow 15 by the distance equal to the movement appropriately determined by the controller 6. The quantity of the solvent 10a that can be passed through the discharge flow path 14b is then adjusted accordingly.

The solvent 10a is then supplied to the packing material packer 4 while the solvent 10a is being maintained at the appropriate flow rate and pressure level. The supply flow path 14a connecting between the packing material packer 4 and the liquid delivery pump 9 includes a pressure sensor 7 which is always measuring the pressure level of the solvent 10 in the supply flow path 14a and in the packing material packer 4, and the corresponding control signals that represent the pressure levels as measured by the pressure sensor 7 are transmitted to the controller 6.

An appropriate amount of the packing material is added to the solvent 10a supplied to the packing material packer 4, and the packing material slurry 12 formed by the packing material dispersed in the solvent 10 is then prepared.

The packing material slurry 12 thus prepared is then packed into the column structure 2 from the packing material packer 4. The packing material slurry 12 is being deposited to form a layer within the column structure 2, and the solvent 10a contained in the packing material slurry 12 is then passed through a filter 3 fixedly mounted to the lower end 2b of the column structure 2 through which the solvent 10a is discharged to the discharge flow path 14b through which it is then discharged to the discharge container 11.

It may be understood from the foregoing description that the amount of the solvent 10a that can be passed through the discharge flow path 14b will be varied, depending on the distance of the variable resistor 5 that has been moved through the discharge flow path 14b. The distance of the movement of the variable resistor 5 through the discharge flow path 14b corresponds to the flow rate and pressure level of the solvent 10a required to maintain the flow rate and pressure level at their respective values as determined by the controller 6.

In the manner described above, the flow rate and pressure level of the solvent 10a within the packing material packer 4 and column structure 2 can be maintained to be constant during the period from the time when the packing process for the packing material slurry 12 is begun through the time when that packing process is ended.

By maintaining the pressure level in the column structure 2 to be constant, the packing material can have the uniform particle density, and by maintaining the flow rate of the packing material slurry 12 through the column structure 2 to be constant, the packing material slurry 12 can be deposited with a constant speed. In this way, the packing material can be deposited to form a uniform layer within the column structure 2.

It may be appreciated that the column structure packed by the column packing apparatus and method that have been described so far allows the packing material to be deposited to form the uniform layer therein, thus allowing the uniform pressure to be produced without causing any differences in the pressure for each individual column structure. The column structures thus packed have the ability to resolve the mixture sample with high reproducibility, reliability and stability.

### DESCRIPTION OF REFERENCE NUMERALS

1 Column packing apparatus
2 Column structure
2a Upper end
2b Lower end
3 Filter
4 Packing material packer
5 Variable resistor
5a Flow path opening/closing needle
5b Needle receiver
6 Controller
7 Pressure sensor
8 Motor
9 Liquid delivery pump
10 Solvent supply container
10a Solvent
11 Discharging container
11a Eluate
12 Packing material slurry
13 Pressure sensor
14a Solvent supply flow path
14b Solvent discharge flow path

1. A column packing apparatus wherein the column structure is designed for use in the chromatographic separation, the apparatus comprising:
a tubular structure;
a packing material supplier disposed on one end of said tubular structure for permitting a packing material slurry formed by a packing material dispersed in a solvent to be packed into said tubular structure; and
a packing controller disposed on the other end of said tubular structure for maintaining the flow rate and pressure of said packing material slurry formed by said packing material being packed at predetermined flow rate and pressure level.

2. A column packing apparatus as defined in claim 1, wherein said packing controller includes:
a resistive element for variably adjusting the discharging rate of said solvent being discharged from said other end of said tubular structure, wherein said resistive element is a resistor capable of variably adjusting the discharging rate of said solvent so that the flow rate and pressure of said packing material slurry can be maintained at said predetermined flow rate and pressure level.

3. A column packing method wherein the column structure is designed for use in the chromatographic separation, the method comprising the steps of:
providing a tubular structure;
providing a packing material supplier disposed on one end of said tubular structure;
packing a packing material slurry formed by a packing material dispersed in a solvent into said tubular structure from said packing material supplier;
providing a packing controller disposed on the other end of said tubular structure; and
permitting said packing controller to variably adjusting the flow rate and pressure of said packing material slurry so that they can be maintained at predetermined flow rate and pressure level.

4. A column packing method as defined in claim 3, wherein said packing controller includes a resistive element for variably adjusting the discharging rate of said solvent being discharged from said other end of said tubular structure, wherein said resistive element is a resistor capable of variably adjusting the discharging rate of said solvent so that the flow rate and pressure of said packing material slurry can be maintained at said predetermined flow rate and pressure level.
